(19) United States
(12) Patent Application Publication
(10) Pub. No.: US 2012/0243240 A1
(43) Pub. Date: Sep. 27, 2012

(54) LIGHT SOURCE APPARATUS

(76) Inventors: Naotaka Hashimoto, Osaka (JP); Shinya Kawagoe, Osaka (JP); Toshikazu Endo, Osaka (JP); Kazuhiko Itoh, Osaka (JP); Keiji Amano, Osaka (JP)

(21) Appl. No.: 13/390,668

(22) PCT Filed: Jul. 29, 2011
(86) PCT No.: PCT/JP2011/004345

§ 371 Date: Feb. 15, 2012

(30) Foreign Application Priority Data
Jan. 14, 2011 (JP) 2011-006413

(51) Int. Cl. B60Q 3/00

(52) U.S. Cl. 362/368

(57) ABSTRACT

The present invention aims to provide a light source apparatus including a small case housing therein a circuit unit including a tall electronic part and a wide mounting substrate. A light source apparatus 1 comprises: a light emitting module 20 as a light source; a circuit unit 60 including a plurality of electronic parts 61a-61f for lighting the light emitting module 20 and a mounting substrate 62 on which the electronic parts 61a-61f are mounted; and a case 70 that is tubular and has an opening at one end thereof, the case 70 housing therein the circuit unit 60. The mounting substrate 62 is held by the case 70 so as to be slanted with respect to a tube axis of the case 70 and not to intersect the tube axis.

### TECHNICAL FIELD

The present invention relates to a light source apparatus that utilizes, as the light source, a light emitting module such as a light emitting diode (LED) module.

### BACKGROUND ART

Conventionally, a light source apparatus for which an LED module is used as the light source is used as the substitute for halogen bulbs or incandescent bulbs. Such a light source apparatus is generally provided with a circuit unit. The circuit unit is composed of a mounting substrate and a plurality of electronic parts mounted on the mounting substrate. The plurality of electronic parts are for lighting the LED module. The circuit unit is placed in a case which is insulative.

One approach to reduce the size of the above light source apparatus is to reduce the size of the case. However, in this case, the case has a reduced internal volume, and accordingly it is difficult to house a circuit unit having the conventional size in the case. In order to solve this problem, Patent Literature 1 discloses vertical arrangement according to which a circuit unit is vertically arranged in a case having a cylindrical shape. The vertical arrangement refers to arranging the circuit unit so that a mounting substrate becomes parallel with the cylinder axis of the case, and enables the case to efficiently house therein the mounting substrate that is one of the largest parts.

### CITATION LIST

### Patent Literature

[Patent Literature 1]
Japanese Patent Application Publication No. 2010-212073

### SUMMARY OF INVENTION

### Technical Problem

When a circuit unit is vertically arranged in a cylindrical case, it is preferable to arrange a mounting substrate close to the cylinder axis of the case. This allows an area having the largest width within the case to be effectively utilized, and accordingly a mounting substrate that is substantially the same in width as the inner diameter of the case can be housed.

However, when the mounting substrate is arranged close to the cylinder axis, the largest distance between a surface of the mounting substrate on which electronic parts are mounted and the inner circumferential surface of the case is approximately a half of the inner diameter of the case. Therefore, it is difficult to mount a tall electronic part on the mounting substrate.

In view of the above problem, the present invention aims to provide a light source apparatus including a small case housing therein a circuit unit that includes a tall electronic part and a wide mounting substrate.

### Solution to Problem

In order to achieve the above aim, a light source apparatus pertaining to the present invention comprises: a light emitting module as a light source; a circuit unit including a plurality of electronic parts for lighting the light emitting module and a mounting substrate on which the electronic parts are mounted; and a case that is tubular and has an opening at one end thereof, the case housing therein the circuit unit, wherein the mounting substrate is held by the case so as to be slanted with respect to a tube axis of the case and not to intersect the tube axis.

### Advantageous Effects of Invention

The light source apparatus pertaining to the present invention is held by a case so as to be slanted with respect to the cylinder axis of the case and not to intersect the cylinder axis. Accordingly, the largest distance between a main surface of a mounting substrate facing the cylinder axis and the inner circumferential surface of the case can be increased, compared to when the mounting substrate is vertically arranged. Therefore, a taller electronic part can be mounted on the mounting substrate, and the case can house therein the mounting substrate that is substantially the same in width as when the mounting substrate is vertically arranged.

### BRIEF DESCRIPTION OF DRAWINGS

FIG. 1 is a perspective view showing a light source apparatus pertaining to the present embodiment.

FIG. 2 is an exploded sectional view showing the light source apparatus pertaining to the present embodiment.

FIG. 3 is a perspective view showing a circuit unit pertaining to the present embodiment.

FIG. 4 is a sectional perspective view showing a case and a base pertaining to the present embodiment.

FIG. 5 is a cross-sectional view showing a state in which the circuit unit is housed in the case.

FIG. 6 is a plan view showing a state in which the circuit unit is housed in the case.

FIG. 7 is a cross-sectional view for explaining arrangement according to which a length of a segment of a mounting substrate from the intersection with the cylinder axis is short.

FIG. 8 is a cross-sectional view showing a state in which a circuit unit of a light source apparatus pertaining to a modification is housed in a case.

### DESCRIPTION OF EMBODIMENT

An embodiment of a light source apparatus pertaining to the present invention is described below with reference to the drawings. Note that members shown in each drawing are not drawn to scale. In addition, in the present application, the character “-” in numerical ranges indicates that the values on both sides are included in the range. Furthermore, in each drawing, a dashed-dotted line indicates an axis J of a lamp (lamp axis J). A direction indicated by an arrow X, which is parallel with the lamp axis J, is a direction that the light source apparatus faces and is a lighting direction of the light source apparatus.

(Schematic Structure)

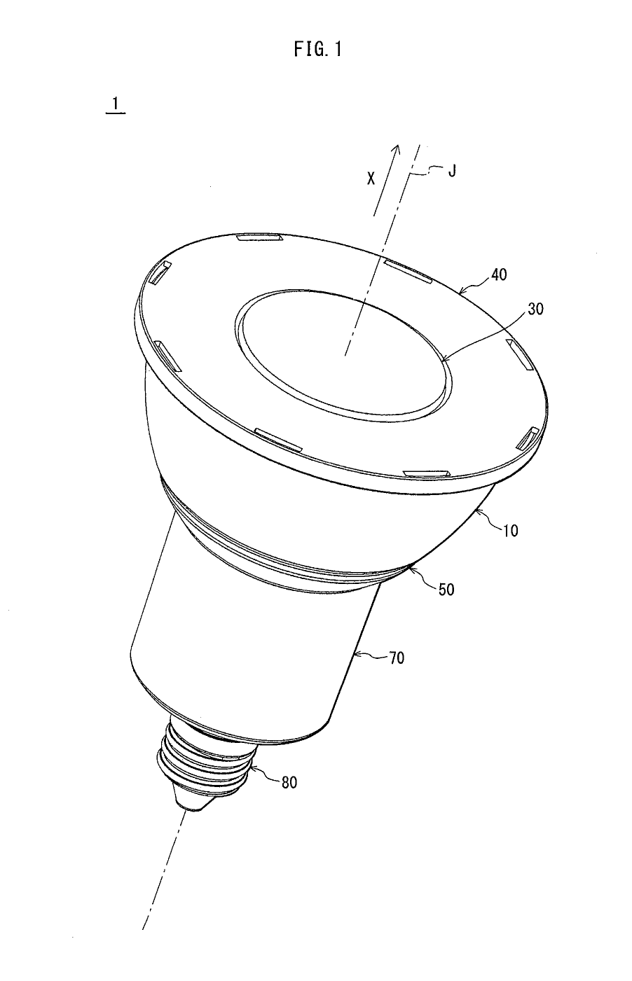

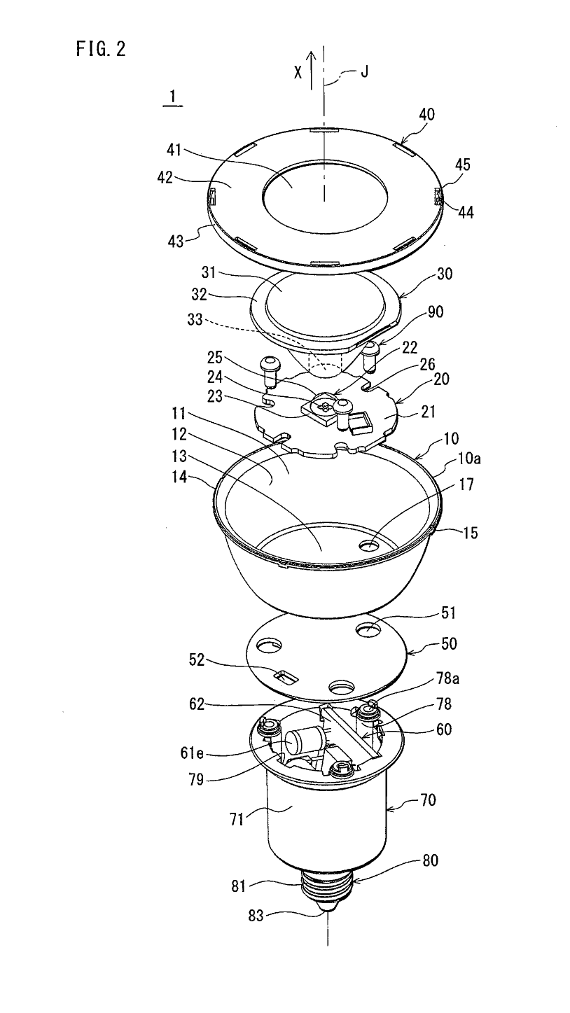

FIG. 1 is a perspective view showing a light source apparatus pertaining to the present embodiment. FIG. 2 is an exploded sectional view showing the light source apparatus pertaining to the present embodiment.

As shown in FIG. 1, the light source apparatus pertaining to the present embodiment is an LED lamp 1 that has a shape conforming to the standard for halogen bulb defined in JIS C 7527, and can be a substitute for a halogen bulb. As shown in FIG. 2, the LED lamp 1 includes a body 10, a light emitting module 20, an optical member 30, a front cover 40, an insulation member 50, a circuit unit 60, a case 70, and a base 80.

(Body)

The body 10 is in a bowl shape, having an opening 11 on the front side. The body 10 includes a cylindrical portion 12 and a bottom 13. The body 10 gradually increases in diameter from the rear to the front. The bottom is substantially in the shape of a circular plate and seals off the rear side of the cylindrical portion 12. The cylinder axis of the cylindrical portion 12, which is also the cylinder axis of the body 10, coincides with the lamp axis J.

Note that a shape of the body 10 is not limited to the above. For example, the body may be a cylinder having openings on both of the front and rear sides. Alternatively, the body may be an elliptic tube or a rectangular tube, other than a cylinder. Furthermore, the cylindrical portion 12 may gradually reduce in diameter from the rear to the front, or may be uniform in diameter along the cylinder axis.

The body 10 houses therein the light emitting module 20 and the optical member 30. The body 10 is made of metal, and accordingly acts as a heat sink that radiates heat generated by the light emitting module 20 housed in the body 10. As metal used for the body 10, aluminum is preferable when the heat dissipation, heat resistance, light weight, and the like are taken into account.

An open end 10a of the cylindrical portion 12 is provided with a flange 14 that is in substantially an annular shape so as to surround the opening 11. The front cover 40 is attached to the open end 10a by engaging claws 44 of the front cover 40 with the flange 14. Furthermore, the rear side of the flange 14 is provided with a plurality of protrusions 15 located at intervals along the circumferential direction of the flange. The protrusions 15 prevent the front cover 40 from rotating on the body 10. That is, when the front cover 40 rotates about the lamp axis J, the claws 44 rotate and come into contact with protrusions 15, and as a result the front cover 40 stops rotating on the body 10. Note that any number of the protrusions 15 may be provided.

(Light Emitting Module)

The light emitting module 20 is a light source of the LED lamp 1, and includes a module substrate 21 and an LED unit 22. The LED unit 22 is mounted approximately in the center of the module substrate 21. The light emitting module 20 is placed approximately in the center of the bottom 13 in the body 10. The LED unit 22, for example, includes: a unit substrate 23; LED chips 24 of the InGaN type with blue emission light mounted on the unit substrate 23; and a substantial semispherical sealing member 25 that contains a phosphor for emitting yellow-green light and seals the LED chip 24 therein. The LED unit 22 converts a part of blue light emitted from the LED chips 24 to yellow-green by the phosphor, and emits white light that is generated as a mixture of blue light and yellow-green light.

(Optical Member)

The optical member 30 is made of a translucent material such as transparent acrylic resin, and includes a lens 31 and an outer edge 32 that are integrated as one piece. The lens 31 is in the shape of substantially a truncated cone. The outer edge 32 is in the shape of substantially a ring-like plate, and provided as an extension from the circumferential surface of the lens 31.

The lens 31 is located approximately in the center of the inside of the body 10 and in front of the light emitting module 20. The lens 31 has a concave part 33 having the shape of an approximate cylinder at a rear end thereof, and by fitting the sealing member 25 of the LED unit 22 into the concave part 33, the position of the optical member 30 is determined relative to the LED unit 22.

The light emitted from the light emitting module 20 enters the lens 31 mainly from the concave part 33, passes through the lens 31, and is extracted to outside of the body 10 from a front face of the lens 31. The light distribution property of the emitted light changes when the light passes through the lens 31. To be specific, focused by the lens 31, the emitted light becomes a spotlight similar to the light emitted from a mirrored halogen bulb. Note that the front face of the lens 31 has been processed to have the light diffusion function. For example, the front face is provided with a plurality of convexities and concavities for diffusing the emitted light.

The outer edge 32 is at the rear side of the front cover 40 to seal the opening 11 of the body 10, and a front face of the outer edge 32 and the rear face of the front cover 40 are in surface contact. Since the outer edge 32 and the front cover 40 are in surface contact, the heat is likely to transfer from the optical member 30 to the front cover 40. Thus the heat generated in the LED unit 22 can be released, via the optical member 30, from the front cover 40 to outside efficiently. In addition, the front face of the outer edge 32 is covered by the front cover 40. This makes the outer appearance of the LED lamp 1 excellent in that the light emitting module 20 housed in the body 10 is difficult to be seen through from outside. When the cover 40 is translucent, the cover passes through the light that slightly leaks from the optical member 30, and enables the light to be emitted from the whole front face of the lamp.

(Front Cover)

The front cover 40 includes: a main body 42 that is in the shape of a ring-like plate and has an approximately circular light emission window 41; and a circumferential wall 43 that is in the shape of a short cylinder extending backward from the outer circumferential edge of the main body 42. Note that a shape of the front cover 40 is not limited to the above, and may be any shape that matches a shape of the opening 11 of the body 10.

The front cover 40 is made of a nontranslucent resin such as white polybutylene terephthalate (PBT). PBT is preferred as a material of the cover 40 since it has high heat resistance, moderate elasticity, and high weather resistance. Note that the resin that constitutes the front cover 40 is not limited to PBT, but may be acrylic, polycarbonate (PC) or the like. In addition, the color of the front cover 40 is not limited to white, and any color may be provided. The front cover 40 may be transparent or translucent.

The circumferential wall 43 is provided with the plurality of claws 44 located at intervals along the circumferential direction of the circumferential wall 43. For example, the claws 44 are provided at equal interval in the inner circumferential surface of the circumferential wall 43 near the rear end thereof, along the circumferential direction of the circumferential wall 43, so as to project toward the lamp axis J. Note that any number of the claws 44 may be provided.

The main body 42 is provided with holes 45 at positions corresponding to the claws 44. With this structure having the holes 45, it is possible to form the complicated-shaped front cover 40 by molding from resin, by using a simple mold constituted from a smaller number of parts. This realizes simplified molding.

The front cover 40 biases the optical member 30 backward. This causes the front cover 40 and the outer edge 32 to be in surface contact, and causes the lens 31 to be in contact with the light emitting module 20. This restricts the movement of the optical member 30 in the front and rear direction, preventing the positional shift and backlash of the optical member 30. Also, since the front cover 40 and outer edge 32 is in close contact, the heat is allowed to transfer from the optical member 30 to the front cover 40. This improves the heat radiation of the LED lamp 1.

(Insulation Member)

The insulation member 50 is for ensuring the insulation between the circuit unit 60 and the body 10, and is made of an insulation material such as resin or ceramic. The insulation member 50 is shaped like a roughly circular flat disc, and substantially the same in diameter as the bottom 13 of the body 10. The insulation member 50 is at the back of the bottom 13.

Note that the insulation member 50 is not essential. When the insulation member 50 is not provided, a part of electronic parts 61a-61f included in the case 70 may be in contact with the body 10. This can release the heat generated by the electronic parts 61a-61f toward the body 10.

(Circuit Unit)

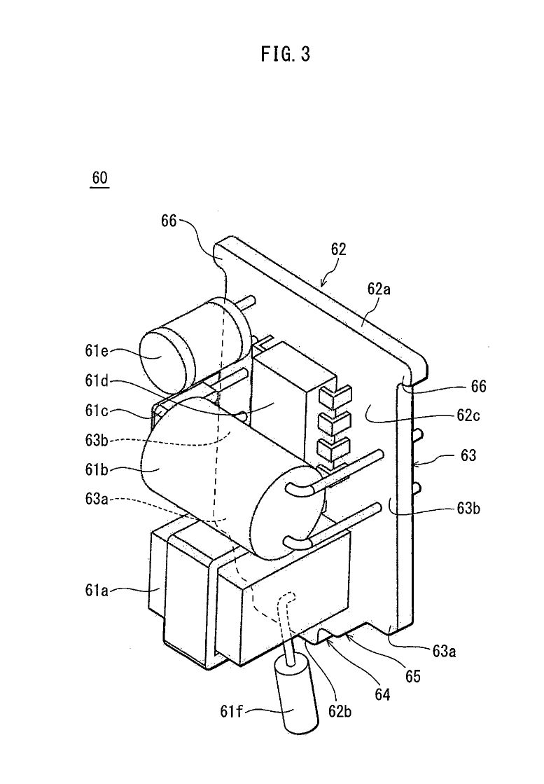

FIG. 3 is a perspective view showing a circuit unit pertaining to the present embodiment. As shown in FIG. 3, the circuit unit 60 is provided with: a rectifier circuit that rectifies an AC power supplied from a commercial power source to a DC power; and a lighting circuit composed of components such as a voltage adjustment circuit that adjusts a voltage value of the DC power rectified by the rectifier circuit, for example. The circuit unit 60 is electrically connected with the base 80 and the LED unit 22, receives power from lighting equipment (unillustrated) via the base 80, and causes the LED chips 24 of the LED unit 22 to emit light.

The circuit unit 60 is provided with the electronic parts 61a-61f for lighting an LED module, i.e., a choke coil 61a, an electrolytic capacitor 61b, a capacitor 61c, an IC 61d, a noise filter 61e, and a resistance 61f. The circuit functions of the circuit unit 60 are realized by the electronic parts 61a-61f that are mounted on a plate-like mounting substrate 62.

The mounting substrate 62 is composed of a main part 63, an edge part 64, a connecting part 65, and a pair of convex parts 66. The main part 63 is located in the front part of the case 70. The edge part 64 is located in the rear part of the case 70. The connecting part 65 connects the main part 63 and the edge part 64. The pair of convex parts 66 laterally extend from the front end of the main part 63. A front end 62a of the mounting substrate 62 (end that is closer to an opening 70a of the case 70) is composed of the front end of the main part 63 and the pair of convex parts 66. A rear end 62b of the mounting substrate 62 (end that is farther from the opening 70a of the case 70) is composed of the rear end of the edge part 64.

The main part 63 has substantially a rectangular shape and gradually decreases in width (in a direction parallel with main surfaces 62c and 62d of the mounting substrate 62, and perpendicular to the lamp axis J, and hereinafter, “width” with respect to the mounting substrate 62 refers to the width in the above direction) from the rear side to the front side. The choke coil 61a, the electrolytic capacitor 61b, the capacitor 61c, the IC 61d, and the noise filter 61e are mounted on the main part 63. The connecting part 65 has substantially a trapezoidal shape and gradually decreases in width from the front side to the rear side. The resistance 61f is mounted on the connecting part 65. The edge part 64 has substantially a rectangular shape and is smaller than the main part 63 in width. Each of the convex parts 66 has substantially a square shape, and an edge of each convex part in a widthwise direction of the main part 63 has an R shape.

(Case)

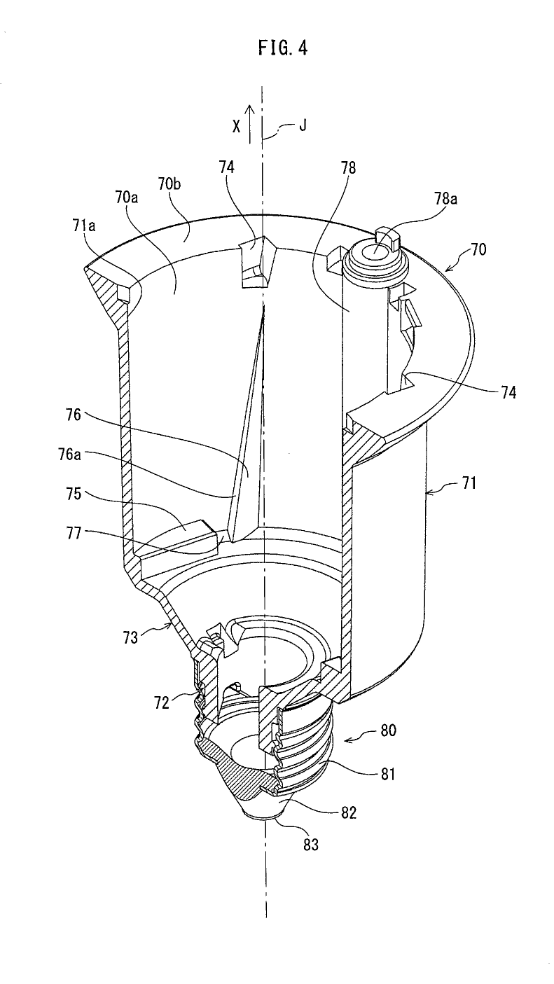

FIG. 4 is a sectional perspective view showing the case and the base pertaining to the present embodiment. As shown in FIG. 4, the case 70 is a cylinder whose front end and rear end are open, and includes a large diameter part 71, a small diameter part 72, and a reduced diameter part 73. The small diameter part 72 is smaller than the large diameter part 71 in inner and outer diameters. The reduced diameter part 73 connects the large diameter part 71 and the small diameter part 72. The large diameter part 71 is located in the front part of the case 70, and the small diameter part 72 is located in the rear part of the case 70. The reduced diameter part 73 gradually decreases in diameter from the front side to the rear side.

Note that a shape of the body 70 is not limited to the above. For example, the case may be a cylinder with a bottom where its rear end is not open. Alternatively, the case may be an elliptic tube or a rectangular tube, other than a cylinder. In addition, the diameters of the large diameter part 71, the small diameter part 72, and the reduced diameter part 73 may change in any way, and may be uniform.

The case 70 is provided with a function that ensures the insulation of the circuit unit 60, and is made of an insulating material such as a resin or ceramic. The case 70 is attached to the rear side of the body 10, with the front opening 70a sealed off by the insulation member 50. The circuit unit 60 and the body 10 are electrically insulated by the insulation member 50.

An inner circumferential surface 71a of the large diameter part 71, which is also the inner circumferential surface of the case 70, is provided with second positioning parts 74 for determining the position of the front end 62a of the mounting substrate 62. The second positioning parts 74 are each a concavity provided at one edge of the inner circumferential surface of the case 70 so that a portion of an end face 70b of the case 70 is cut out, the one edge being closer to the opening 70a than the other edge, the end face 70b having the opening 70a. By fitting the pair of convex parts 66 of the mounting substrate 62 into the concavities, the position of the front end 62a of the mounting substrate 62 is determined.

The inner circumferential surface 71a of the large diameter part 71, to be more specific, portions of the inner circumferential surface 71a of the large diameter part 71 are provided with a pair of projections 75 facing each other, the portions being close to the rear end of the large diameter part 71. The pair of the projections 75 prevent the rear end 62b of the mounting substrate 62 from moving toward the lamp axis J. The inner circumferential surface 71a of the large diameter part 71, to be more specific, other portions of the inner circumferential surface 71a of the large diameter part 71 are provided with a pair of ribs 76 facing each other along the lamp axis J, the other portions extending from the rear end of the large diameter part 71 to the vicinity of the front end of the large diameter part 71. The pair of the ribs 76 prevent the rear end 62b of the mounting substrate 62 from moving away from the lamp axis J. One of the projections 75 and a corresponding one of the ribs 76 are adjacent to each other. The projections 75 and the respective ribs 76 form first positioning parts 77 for determining the position of the rear end 62b of the mounting substrate 62. Each of lateral ends of the rear end 63a of the main body 63 of the mounting substrate 62 is inserted into a gap between one of the projections 75 and the corresponding one of ribs 76. Thus, the position of the rear end 63a of the main body 63 is determined. This also determines the position of the rear end 62a of the mounting substrate 62.

Each of the ribs 76 includes a slanted surface 76a. The main surface 62d of the mounting substrate 62 not facing the lamp axis J comes into contact with the slanted surface 76a. The slanted surfaces 76a are included in the same virtual plane.

The inner circumferential surface 71a of the large diameter part 71 is provided with three protrusions 78 at equal interval in the circumferential direction. Each of the protrusions 78 extends from the front end of the large diameter part 71 to the rear end thereof, and screw holes 78a are formed on the front side of the protrusions 78. Note that instead of the slanted surfaces 76a of the ribs 76, a part of the surface of each protrusion 78 may be a slanted surface.

(Base)

The base 80 receives the electric power supplied from a socket (unillustrated) of lighting equipment when the LED lamp 1 is attached to the lighting equipment and lighted. Although no particular restriction is intended regarding a type of the base 80, E11 base, which is an Edison type base, is used in the present embodiment. The base 80 has a shell 81 and an eyelet 83, and is fit onto the small diameter part 72 of the case 70. The shell 81 is substantially cylindrical, and a male screw is provided on the outer circumferential surface of the shell 81. The eyelet 83 is attached to the shell 81 via an insulation portion 82.

(Assembling of Light Source Apparatus)

As shown in FIG. 2, the bottom 13 of the body 10 is provided with a plurality of screw holes 17 for screw clamp and a wiring hole (unillustrated) for wiring. Also, the insulation member 50 is provided with a plurality of screw holes 51 and a wiring hole 52. Furthermore, the module substrate 21 of the light emitting module 20 is provided with a plurality of screw holes 26. Each of the screws 90 is inserted into one of the screw holes 26 of the module substrate 21, one of the screw holes 17 of the body 10, and one of the screw holes 51 of the insulation member 50 in the stated order. Each of the screws 90 is further screwed into a corresponding one of the screw holes 78a of the case 70. Thus, the body 10, the light emitting module 20, the insulation member 50 and the case 70 are integrally assembled.

The wiring (unillustrated) of the light emitting module 20 extends to an inside of the case 70 via a wiring hole 18 of the body 10 and the wiring hole 52 of the insulation member 50, and is electrically connected to the circuit unit 60. A concavity 79 that corresponds to the wiring hole 52 is formed at one edge of the inner circumferential surface of the case 70 so that a portion of the end face 70b of the case 70 having the opening 70a is cut out, the one edge being closer to the opening 70a than the other edge. The wiring runs through the concavity 79, and accordingly the position of the wiring is determined to be located at a predetermined position within the case 70.

(Structure According to which Circuit Unit is Housed in Case)

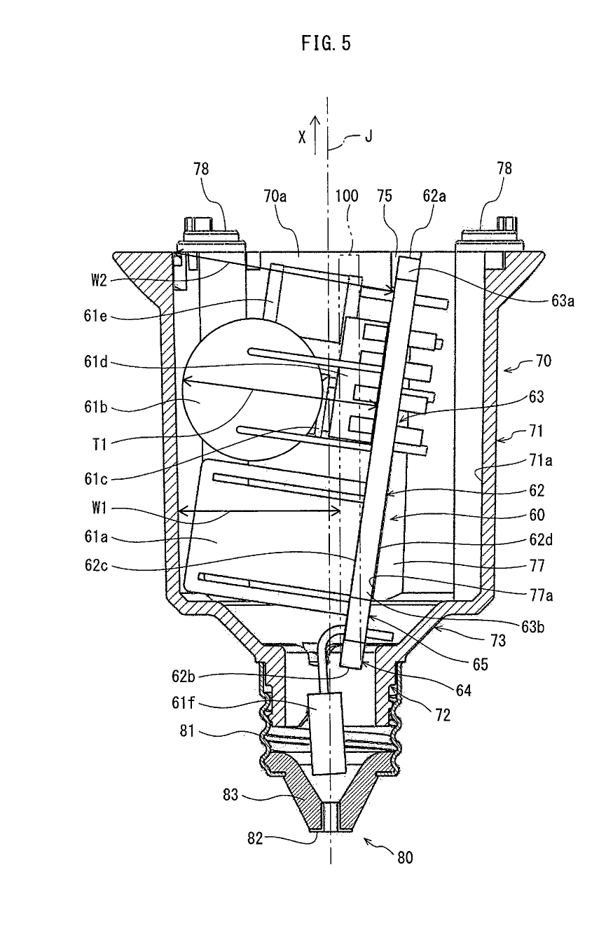

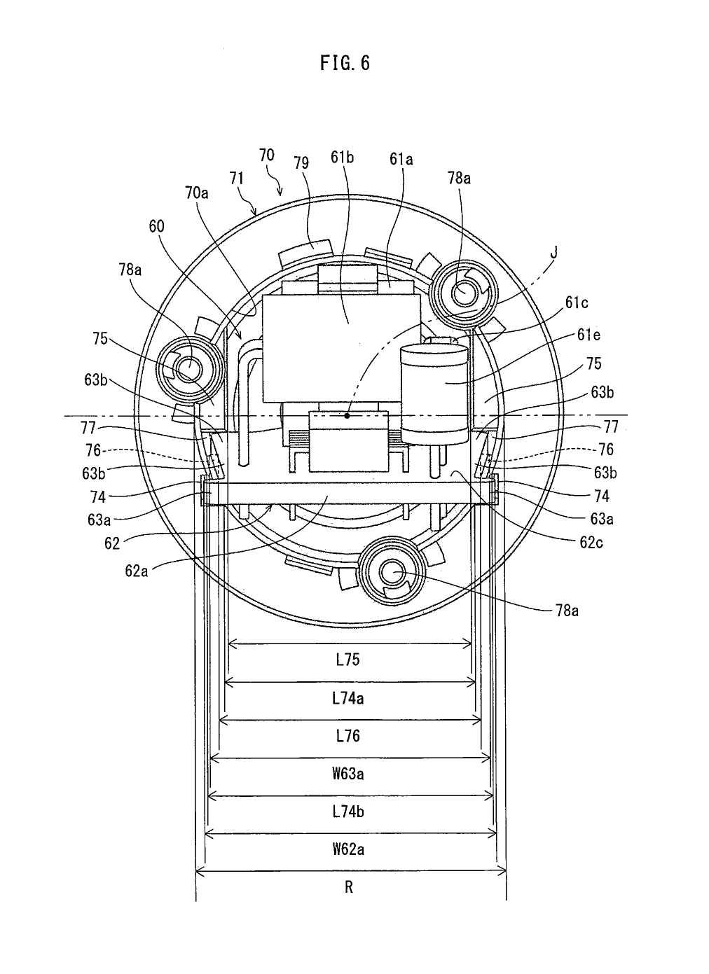

FIG. 5 is a cross-sectional view showing a state in which the circuit unit is housed in the case. FIG. 6 is a plan view showing a state in which the circuit unit is housed in the case.

As shown in FIG. 5, the mounting substrate 62 is held by the case 70 so as to be slanted with respect to the cylinder axis of the case 70, which coincides with the lamp axis J, and not to intersect the cylinder axis so that the front end 62a is farther from the cylinder axis than the rear end 62b. To be specific, by fitting the convex parts 66 of the mounting substrate 62 and the rear end 63a of the mounting substrate 62 into the second positioning parts 74 and the first positioning parts 77, respectively, the mounting substrate 62 is held so as to be slanted with respect to the cylinder axis and not to intersect the cylinder axis.

As shown in FIG. 6, a width W62a of the front end 62a of the mounting substrate 62 is larger than a length L74b between edges of the second positioning parts 74 facing the lamp axis J (the width W62a and the length L74b are parallel with each other). Accordingly, the front end 62a does not move toward the lamp axis J. Furthermore, the width W62a is larger than a length L74a between edges of the second positioning parts 74 not facing the lamp axis J (the width W62a and the length L74a are parallel with each other). Accordingly, the front end 62a does not move away from the lamp axis J.

Moreover, a width W63a of the rear end 63a of the main body 63 of the mounting substrate 62 is larger than a length L75 between the projections 75. Accordingly, the rear end 62b does not move toward the lamp axis J. In addition, the width W63a is larger than a length L76 between the ribs 76. Accordingly, the rear end 62b does not move away from the lamp axis J.

Thus, by determining the position of the mounting substrate 62 by two points separated in the front and rear direction, the mounting substrate 62 can be stably held so as to be slanted at a predetermined angle. Also, it is possible to prevent the mounting substrate 62 from moving toward and then intersecting the lamp axis J.

The position of the rear end 62b of the mounting substrate 62 is determined so as to be close to the lamp axis J. As a result, it is possible to effectively use an area having the largest width within the case 70, and the case 70 can house therein the mounting substrate 62 having the rear end 62b that is substantially the same in width as an inner diameter R of the large diameter part 71. Note that a width of the mounting substrate 62 is designed to gradually decrease from the rear side toward the front side. This is because the mounting substrate 62 is slanted so that a distance from the lamp axis J gradually increases from the rear side of the mounting substrate 62 toward the front side thereof, and a distance between two points on the inner circumference of the case 70 decreases as a distance between a line connecting the two points and the lamp axis J increases.

The main body 63 of the mounting substrate 62 is housed in the large diameter part 71 of the case 70. The connecting part 65 is housed in the reduced diameter part 73. The edge part 64 is housed in the small diameter part 72. The width of the main body 63 is designed to correspond to the inner diameter of the large diameter part 71 of the case 70. The width of the connecting part 65 is designed to correspond to the inner diameter of the reduced diameter part 73. The width of the edge part 64 is designed to correspond to the inner diameter of the small diameter part 72. Regarding the electronic parts 61a-61f, the choke coil 61a, the electrolytic capacitor 61b, the capacitor 61c, the IC 61d, and the noise filter 61e, which are mounted on the main part 63, are mainly housed in the large diameter part 71, and the resistance 61f mounted on the connecting part 65 is mainly housed in the small diameter part 72. Note that electronic parts may be mounted on the main surface 62d of the mounting substrate 62 not facing the lamp axis J.

As shown in FIG. 5, the electronic parts 61a-61f are mounted on the main surface 62c of the mounting substrate 62 facing the lamp axis J. The electrolytic capacitor 61b, which is the tallest electronic part, is disposed at the central area of the main body 63 in the front and rear direction, and the choke coil 61a, which is the second tallest electronic part, is disposed at the rear of the main body 63.

When the circuit unit 60 is vertically arranged and the mounting substrate 62 is arranged as shown by the lines with alternate long and two short dashes 100, the largest distance W1 between the main surface 62c of the mounting substrate 62 facing the lamp axis J and the inner circumferential surface 71a of the large diameter part 71 (the largest value of the width between the main surface 62c and the inner circumferential surface 71a in a direction vertical to the main surface 62c) is substantially the same as a half of the inner diameter of the large diameter part 71.

However, like the LED lamp 1 pertaining to the present embodiment, when the mounting substrate 62 is slanted so as not to intersect the lamp axis J, the largest distance W2 between the main surface 62c and the inner circumferential surface 71a is larger than the largest distance W1 in the case of vertical arrangement. Accordingly, the largest distance W2 between the main surface 62c and the inner circumferential surface 71a is larger than a half of the inner diameter of the case 70. Therefore, it is possible to mount a taller electronic part on the main surface 62c of the mounting substrate 62, compared to when the circuit unit 60 is vertically arranged. Note that a height T1 of the capacitor 61b (the height from the main surface 62c) is larger than the largest distance W1 and smaller than the largest distance W2.

The main surface 62d of the mounting substrate 62 not facing the lamp axis J, to be more specific, surfaces of a pair of lateral edges 63b of the main body 63, the surfaces not facing the lamp axis J, are each in contact with a corresponding one of the slanted surfaces 76a of the ribs 76. With this structure, it is possible to stably hold the mounting substrate 62 so as to be slanted at the predetermined angle.

In addition, the slanted surfaces 76a each act as a guide rail while the circuit unit 60 is being housed in the case 70. To be specific, by pressing the rear end 62b of the mounting substrate 62 against the slanted surfaces 76a and sliding the rear end 62b on the slanted surfaces 76a, the circuit unit 60 can be smoothly inserted into a predetermined position in the case 70.

A slant angle of each of the slanted surfaces 76a with respect to the lamp axis J is preferably 3°-15° in order to increase the largest distance W2. When the slant angle is small, it is impossible to increase the largest distance W2, and when the slant angle is large, it is impossible to house the mounting substrate 62 having the large width in the case 70.

The height (length in a direction perpendicular to the width) of the main body 63 of the mounting substrate 62 is larger than the length of the large diameter part 71 of the case 70 in a direction along the lamp axis J. This is realized by slanting the mounting substrate 62.

As described above, since the mounting substrate 62 of the circuit unit 60 is held by the case 70 so as to be slanted with respect to the cylinder axis of the case 70 and not to intersect the cylinder axis, it is possible to increase the largest distance W2 between the main surface 62c of the mounting substrate 62 facing the cylinder axis and the inner circumferential surface 71a of the large diameter part 71, compared to when the mounting substrate 62 is vertically arranged.

When the mounting substrate 62 is slanted with respect to the cylinder axis so that the front end 62a of the mounting substrate 62 is positioned farther from the cylinder axis of the case 70 than the rear end 62b of the mounting substrate 62, the state of the electronic parts 61a-61f and the like that are mounted on the main surface 62c facing the cylinder axis can be seen from the opening 70a. Accordingly, the light emitting module 20 and the circuit unit 60 are easily wired. Furthermore, when the rear end 62b of the mounting substrate 62 is close to the cylinder axis of the case 70, the case 70 can also house a part of the mounting substrate 62 in the small diameter part 72.

Note that in the present application, the expression “not intersect the cylinder axis” includes the meaning “a length of a segment of a mounting substrate from the intersection with the cylinder axis is short”, in addition to the meaning “absolutely not intersect the cylinder axis”. Furthermore, the expression “a length of a segment of a mounting substrate from the intersection with the cylinder axis is short” indicates that a distance from an intersection of the main surface 62c of the mounting substrate 62 facing the lamp axis J and the cylinder axis, which coincides with the lamp axis J, to the rear end of the main surface 62c is slight.

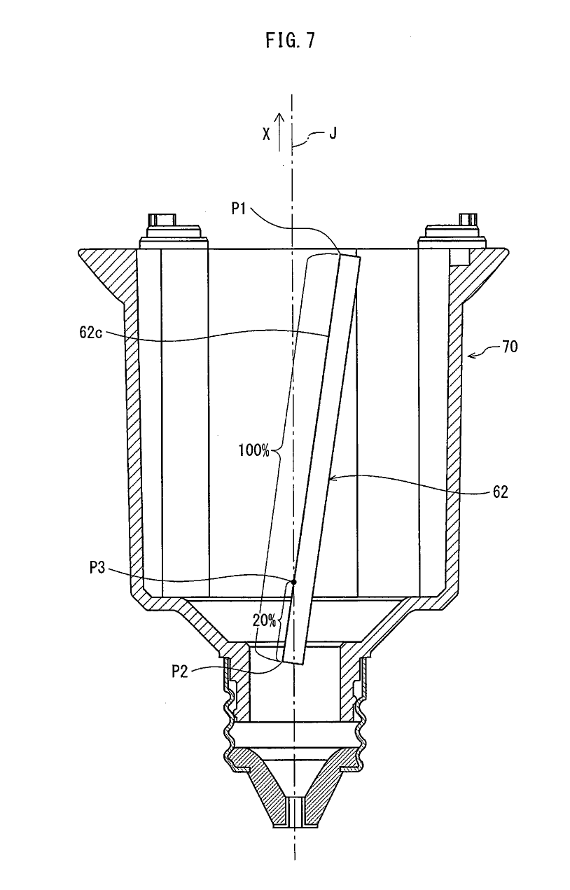

FIG. 7 is a cross-sectional view for explaining arrangement according to which a length of a segment of a mounting substrate from the intersection with the cylinder axis is short, and the electronic parts and the like are omitted. The state where a length of a segment of the main surface 62c from the intersection with the lamp axis J is short indicates, as shown in FIG. 7, that in a cross-section of the LED lamp 1 cut along a plane that is perpendicular to the main surface 62c and includes the lamp axis J, a distance from an intersection P3 of the main surface 62c and the lamp axis J to a rear end P2 of the main surface 62c is equal to or less than 20% of a distance from a front end P1 of the main surface 62c to the rear end P2. Even when the length of the segment of the main surface 62c from the intersection with the lamp axis J is short, the effects of the present invention are yielded. Note that when the distance from the intersection P3 to the rear end P2 is equal to or less than 10% of the distance from the front end P1 to the rear end P2, the effects of the present invention are more noticeable.

### MODIFICATION

In the above, description has been provided on the light source apparatus pertaining to the present invention with reference to the embodiment thereof. However, the light source apparatus of the present invention is not limited to the above embodiment and, the following modification, for example, is possible.

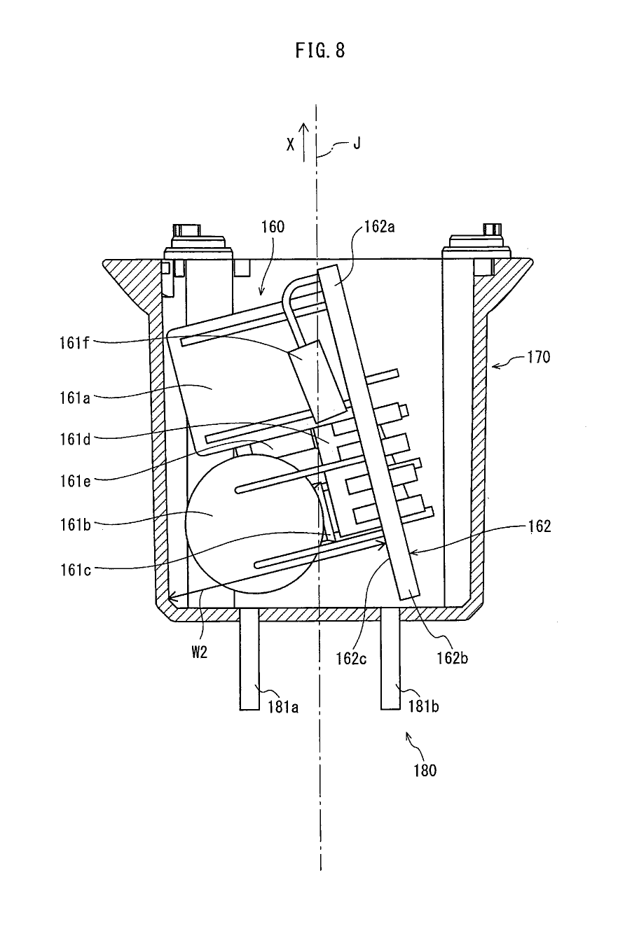

FIG. 8 is a cross-sectional view showing a state in which a circuit unit of a light source apparatus pertaining to the modification is housed in the case. As shown in FIG. 8, a case 170 pertaining to the modification houses therein a circuit unit 160. In addition, a pin-type base 180 having a pair of pins 181a and 181b that are electrically connected to the circuit unit 160 is attached to the case 170. The circuit unit 160 includes a mounting substrate 162 held by the case 170 so as to be slanted with respect to the cylinder axis of the case 170, which coincides with the lamp axis J, so that a rear end 162b is farther from the cylinder axis than a front end 162a. Electronic parts 161a-161f are mounted on a main surface 162c of the mounting substrate 162 facing the lamp axis J.

With this structure, the largest distance W2 can be increased compared to when the circuit unit 160 is vertically arranged. As a result, it is possible to mount a taller electronic part on the main surface 162c of the mounting substrate 162. Note that in this case, the largest distance W2 is measured in the vicinity of the base 180, and accordingly a taller electronic part is disposed in the vicinity of the base 180.

### INDUSTRIAL APPLICABILITY

The light source apparatus of the present invention can be extensively used for lighting in general.

### REFERENCE SIGNS LIST

1 light source apparatus
20 light emitting module
60, 160 circuit unit
61a-61f, 161a-161f electronic part
62, 162 mounting substrate
62a, 162a front end
62b, 162b rear end
62c, 162c main surface facing cylinder axis
62d main surface not facing cylinder axis
66 convex part
70, 170 case
70a opening
70b end face having opening
71a inner circumferential surface
74 second positioning part
76a slanted surface
77 first positioning part

1. A light source apparatus comprising: a light emitting module as a light source; a circuit unit including a plurality of electronic parts for lighting the light emitting module and a mounting substrate on which the electronic parts are mounted; and a case that is tubular and has an opening at one end thereof, the case housing therein the circuit unit, wherein
the mounting substrate is held by the case so as to be slanted with respect to a tube axis of the case and not to intersect the tube axis, and so that one end of the mounting substrate is farther from the tube axis than the other end of the mounting substrate, the one end being closer to the opening than the other end, and
an inner circumferential surface of the case is provided with a first positioning part for determining a position of the other end of the mounting substrate.

2.-3. (canceled)

4. The light source apparatus of claim 1, wherein
the inner circumferential surface of the case is provided with a second positioning part for determining a position of the one end of the mounting substrate.

5. The light source apparatus of claim 4, wherein
the second positioning part is a concavity provided at one edge of the inner circumferential surface of the case so that a portion of a surface of the one end of the case is cut out, the one edge being closer to the opening than the other edge, and
the one end of the mounting substrate is provided with a convexity that fits into the concavity.

6. The light source apparatus of claim 1, wherein
the inner circumferential surface of the case includes a rib having a slanted surface that is slanted along with the mounting substrate, the slanted surface being in contact with one of main surfaces of the mounting substrate, the one main surface not facing the tube axis.

7. The light source apparatus of claim 1, wherein
the case is cylindrical, and a largest distance between one of main surfaces of the mounting substrate and the inner circumferential surface of the case is larger than a half of an inner diameter of the case, the one main surface facing the tube axis.
